(19) United States
(12) Patent Application Publication
(10) Pub. No.: US 2022/0076598 A1
(43) Pub. Date: Mar. 10, 2022

(54) PAIRING DISPLAY DEVICE, PAIRING DISPLAY SYSTEM, AND PAIRING DISPLAY METHOD

(71) Applicant: Mitsubishi Electric Corporation, Tokyo (JP)

(72) Inventors: Miki ARAI, Tokyo (JP); Kei KASUGA, Tokyo (JP); Takayasu HASHIMOTO, Tokyo (JP); Thibaud GENTIL, Tokyo (JP)

(73) Assignee: Mitsubishi Electric Corporation, Tokyo (JP)

(21) Appl. No.: 17/527,165

(22) Filed: Nov. 16, 2021

Related U.S. Application Data
(63) Continuation of application No. PCT/JP2019/024248, filed on Jun. 19, 2019.

(51) Int. Cl. G09G 3/00

(52) U.S. Cl. CPC G09G 3/002; G09G 2370/04; G09G 2354/00

(57) ABSTRACT

A pairing display device includes a detection processing unit for detecting a user who is paired with a movable object having a display unit and a detection unit, by using the detection unit, and an output processing unit for, when the user is detected by the detection processing unit, displaying information showing that the user is paired with the movable object on a floor in the vicinity of the movable object, by using the display unit.

### CROSS-REFERENCE TO RELATED APPLICATION

The present application is a continuation of International Patent Application PCT/JP2019/024248, filed Jun. 19, 2019, the entire contents of which are incorporated herein by reference.

### TECHNICAL FIELD

The present disclosure relates to a pairing display device for, a pairing display system for, and a pairing display method of performing display about the pairing of a movable object and a user.

### BACKGROUND ART

In recent years, attention has been given to facility guidance systems using movable objects. As facilities, for example, hospitals, airports, or commercial facilities are provided. A movable object moves in a facility while carrying a user, or moves while following a user. As the movable object, for example, an electric wheelchair, an electric cart, or a mobile robot is provided. The user can be moved to his or her destination in the facility by the movable object by notifying the movable object of the destination.

When the user uses a movable object provided in the facility, the user needs to perform pairing with a movable object which the user wants to use. The pairing is a process of performing personal authentication to determine whether or not the user is one registered in the system, and, when the user is authenticated as one registered in the system, assigning a movable object as a movable object which can move in accordance with an instruction from the user.

For example, in a system described in Patent Literature 1, a server transmits reservation status data about the current usage reservation status of each robot to a user terminal, and the user terminal transmits reservation data for making a reservation to use a robot, the reservation being inputted by the user in consideration of the reservation status data, to the server. The server determines the reservation to use the robot by authenticating the user on the basis of the reservation data.

### CITATION LIST

### Patent Literature

Patent Literature 1: JP 2005-64837 A

### SUMMARY OF INVENTION

### Technical Problem

In the conventional technology described in Patent Literature 1, a reservation to use a robot, i.e., pairing can be performed using a user terminal. However, a problem is that in a facility where robots are arranged, it is difficult for a user who has performed pairing with a robot without making contact with the robot to know whether or not the user has been actually paired with the robot.

There can also be considered a case in which a robot authenticates a user who has entered the facility and then performs pairing. However, in general, users do not know which robots, out of the robots arranged in the facility, have been paired with other users, and thus do not know with which robot they should make contact for pairing. Therefore, users need to look for an available robot by himself/herself or to ask a manager of the facility for an available robot, which is inconvenient.

The present disclosure is made to solve the above-mentioned problem, and it is therefore an object of the present disclosure to obtain a pairing display device, a pairing display system, and a pairing display method capable of performing display to provide a notification that a movable object and a user are paired with each other.

### Solution to Problem

A pairing display device according to the present disclosure includes: processing circuitry to detect a user who is paired with a movable object having a projector and a detector, by using the detector; and to display, when the user is detected, information showing that the user is paired with the movable object on a floor in the vicinity of the movable object, by using the projector. The processing circuitry displays an image showing a state in which the movable object and the user are paired with each other on the floor in the vicinity of the movable object.

### Advantageous Effects of Invention

According to the present disclosure, the user who is paired with the movable object is detected using the detection unit, and, when the user is detected, the information showing that the user is paired with the movable object is displayed on the floor in the vicinity of the movable object, by using the display unit. By visually recognizing the information displayed on the floor, the user can recognize that the user is paired with the movable object which displays the information.

### BRIEF DESCRIPTION OF DRAWINGS

FIG. 1 is a block diagram showing the configuration of a pairing display device according to Embodiment 1;

FIG. 2 is a flowchart showing a pairing display method according to Embodiment 1;

FIG. 3 is a block diagram showing the configuration of a pairing display system according to Embodiment 1;

FIG. 4A is a block diagram showing a hardware configuration for implementing the functions of the pairing display device according to Embodiment 1;

FIG. 4B is a block diagram showing a hardware configuration for executing software that implements the functions of the pairing display device according to Embodiment 1;

FIG. 5 is a diagram showing an example of display of a state of the pairing of a movable object and a user;

FIG. 6 is a block diagram showing the configuration of a pairing display device according to Embodiment 2;

FIG. 7 is a flowchart showing a pairing display method according to Embodiment 2;

FIG. 8A is a view showing an example of an operation image in Embodiment 2;

FIG. 8B is a view showing a progress situation of an operation on the operation image of FIG. 8A;

FIG. 8C is a view showing the completion of the operation on the operation image of FIG. 8A;

FIG. 9A is a diagram showing an operation on an operation image by a user with a companion;

FIG. 9B is a diagram showing an example of display for confirming a companion;

FIG. 9C is a diagram showing an example of display of a state in which a movable object, and a group of a user and a companion are paired with each other; and

FIG. 10 is a block diagram showing the configuration of a pairing display device according to Embodiment 3.

### DESCRIPTION OF EMBODIMENTS

### Embodiment 1

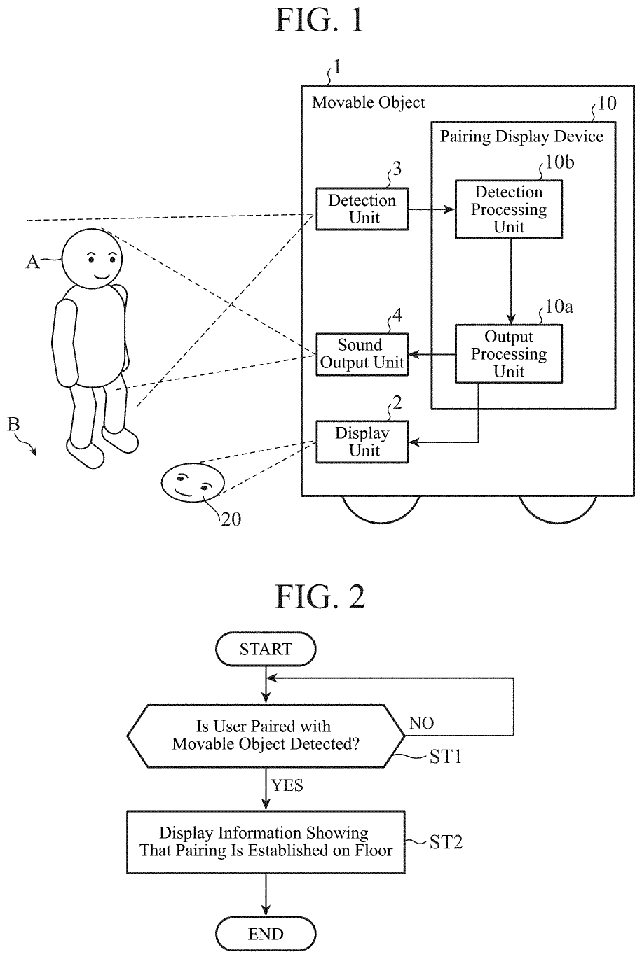

FIG. 1 is a block diagram showing the configuration of a pairing display device 10 according to Embodiment 1. A movable object 1 can perform autonomous movement, and, for example, an electric wheelchair, an electric cart, or a mobile robot is provided as the movable object. The movable object 1 shown in FIG. 1 includes a display unit 2, a detection unit 3, a sound output unit 4, and the pairing display device 10.

The display unit 2 displays information on a floor B in the vicinity of the movable object 1, and is, for example, a projector (projection unit) that projects information onto the floor B. The display unit 2 can also display the information in three dimensions on the floor B in the vicinity of the movable object 1. For example, in the case where the display unit 2 is a projector, the projector projects the information in three dimensions onto the floor B in the vicinity of the movable object 1. Here, “display in three dimensions” or “projection in three dimensions” refers to display or projection of information in a form in which the information can be viewed in a stereoscopic manner by human vision. However, the display unit 2 does not necessarily have to display the information in three dimensions, and may perform two-dimensional display of the information.

The detection unit 3 detects a user A in the vicinity of the movable object 1, and is, for example, a camera device that can capture an image of an area in the vicinity of the movable object 1. The user A is a person who is paired with the movable object 1, and appearance information about the user A is registered in the pairing display device 10. The camera device which is the detection unit 3 captures an image of the user A, and outputs information about the image to the pairing display device 10. The detection unit 3 may be a sensor in which any one of infrared light, light, and an acoustic wave, and a camera device are combined.

The sound output unit 4 outputs a sound to an area in the vicinity of the movable object 1, and is, for example, a speaker. For example, the sound output unit 4 outputs sound effect information, voice guidance, and a warning which are ordered by the pairing display device 10. The sound effect information is sound information corresponding to the information which is displayed by the display unit 2 on the floor B in the vicinity of the movable object 1.

The pairing display device 10 performs display about the pairing of the movable object 1 and the user A. The pairing display device 10 shown in FIG. 1 includes an output processing unit 10a and a detection processing unit 10b. When the user A is detected by the detection processing unit 10b, the output processing unit 10a displays information showing that the user A is paired with the movable object 1 on the floor B in the vicinity of the movable object 1 by using the display unit 2. The information showing that the user A is paired with the movable object 1 is, for example, an image 20 showing at least one of the name of the user A, a face image, or a specific mark. For example, the output processing unit 10a displays the image 20 on the floor B in the vicinity of the movable object 1 at the time that the user A enters the detection range of the detection unit 3.

Further, the output processing unit 10a can display the image 20 in a region which is on the floor B in the vicinity of the movable object 1 and which is the effective detection range of the detection unit 3. The effective detection range is a range where stable detection of an object can be performed by the detection unit 3, and, in the case where the detection unit 3 is, for example, a camera device, the effective detection range is defined by the viewing angle or the like of the camera device. The effective detection range is also referred to as the stable detection range. Because the image 20 is displayed in the region which is the effective detection range of the detection unit 3, the user A can be guided to the region where the user can be detected stably by the detection unit 3.

The image 20 is display information for showing that the user A is paired with the movable object 1, and the image 20 is formed of a graphic, a character, or a combination of a graphic and a character. The image 20 may be an animation image whose display mode varies with time. In the case where the display unit 2 is a projector, the output processing unit 10a projects the image 20 in three dimensions onto the floor B in the vicinity of the movable object 1 by using the projector.

The output processing unit 10a may output a sound corresponding to the information displayed on the floor B in the vicinity of the movable object 1 by using the sound output unit 4. Because the output mode of the sound effect is defined by the frequency, the rhythm, and the tempo of the sound effect, the output processing unit 10a may change these.

The detection processing unit 10b detects the user A who is operating the image 20, by using the detection unit 3. For example, the detection processing unit 10b can perform an image analysis on an image of the area in the vicinity of the movable object 1, the image being captured by the camera device which is the detection unit 3, and detect the user A from the image on the basis of the appearance information about the user A and a result of the image analysis. As the image analysis, for example, an image analysis method such as pattern matching is used.

Next, a pairing display method according to Embodiment 1 will be explained in detail.

FIG. 2 is a flowchart showing the pairing display method according to Embodiment 1.

The detection processing unit 10b detects the user A who is paired with the movable object 1 (step ST1). For example, the detection processing unit 10b performs an image analysis on an image of an area in the vicinity of the movable object 1, the image being captured by the camera device, and detects the user A on the basis of a result of the image analysis. When the user A is not detected (when NO in step ST1), the detection processing unit 10b repeats the detecting process in step ST1 until the user A is detected.

When the user A is detected by the detection processing unit 10b (when YES instep ST1), the output processing unit 10a displays an image 20 on the floor B in the vicinity of the movable object 1 by using the display unit 2 (step ST2). For example, a face image of the user A is displayed, as the image 20, on the floor B, as shown in FIG. 1. The user A can recognize that the user is paired with the movable object 1 which displays the image 20 on the floor B, by visually recognizing the image 20.

Next, a pairing display system according to Embodiment 1 will be explained.

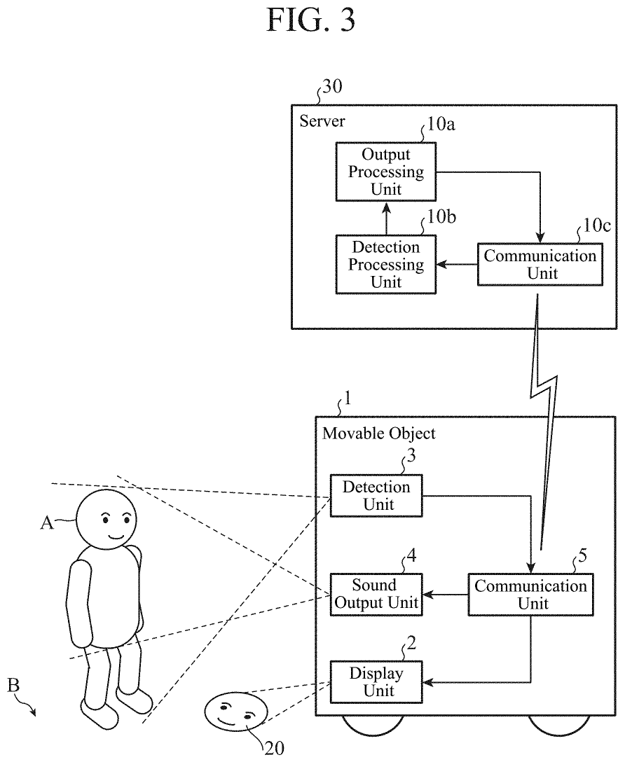

FIG. 3 is a block diagram showing the configuration of the pairing display system according to Embodiment 1.

In FIG. 3, the same components as those shown in FIG. 1 are denoted by the same reference signs, and an explanation of the components will be omitted hereinafter. The pairing display system shown in FIG. 3 displays the fact that the user A and the movable object 1 are paired with each other, and includes the movable object 1 and a server 30.

The movable object 1 can perform autonomous movement, and, for example, an electric wheelchair, an electric cart, or a mobile robot is provided as the movable object. The movable object 1 shown in FIG. 3 includes the display unit 2, the detection unit 3, the sound output unit 4, and a communication unit 5. The communication unit 5 communicates with the server 30. Each of the following units: the display unit 2, the detection unit 3, and the sound output unit 4 operates on the basis of a control signal received, via the communication unit 5, from the server 30.

The display unit 2 displays information on the floor B in the vicinity of the movable object 1 on the basis of control information received, via the communication unit 5, from the server 30. The movable object 1 is, for example, a projector that projects information onto the floor B. The detection unit 3 detects the user A in the vicinity of the movable object 1, and transmits the detection result to the server 30 via the communication unit 5. The sound output unit 4 outputs a sound to an area in the vicinity of the movable object 1 on the basis of control information received, via the communication unit 5, from the server 30.

The server 30 is a device that performs, by using the display unit 2, display about the pairing of the movable object 1 and the user A on the basis of information received from the movable object 1. As shown in FIG. 3, the server 30 includes an output processing unit 10a, a detection processing unit 10b, and a communication unit 10c. The communication unit 10c communicates with the communication unit 5 which the movable object 1 includes.

The output processing unit 10a displays an image 20 on the floor B in the vicinity of the movable object 1, by transmitting a control signal to the movable object 1 via the communication unit 10c to control the display unit 2. The detection processing unit 10b detects the user A, by transmitting a control signal to the movable object 1 via the communication unit 10c to control the detection unit 3.

Next, a hardware configuration for implementing the functions of the pairing display device 10 will be explained.

The functions of the output processing unit 10a and the detection processing unit 10b in the pairing display device 10 are implemented by a processing circuit. More specifically, the pairing display device 10 includes a processing circuit for performing the processes of steps ST1 and ST2 of FIG. 2. The processing circuit may be either hardware for exclusive use or a central processing unit (CPU) that executes a program stored in a memory.

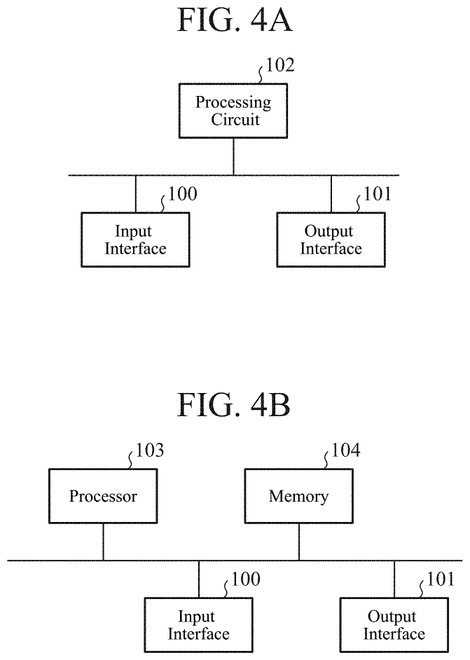

FIG. 4A is a block diagram showing a hardware configuration for implementing the functions of the pairing display device 10. FIG. 4B is a block diagram showing a hardware configuration for executing software that implements the functions of the pairing display device 10. In FIGS. 4A and 4B, an input interface 100 relays information outputted from the detection unit 3 to the detection processing unit 10b which the pairing display device 10 includes. An output interface 101 relays information outputted from the output processing unit 10a to the display unit 2, the sound output unit 4, or both of them.

In the case where the processing circuit is a processing circuit 102 shown in FIG. 4A which is hardware for exclusive use, the processing circuit 102 is, for example, a single circuit, a composite circuit, a programmable processor, a parallel programmable processor, an application specific integrated circuit (ASIC), a field-programmable gate array (FPGA), or a combination of these. The functions of the output processing unit 10a and the detection processing unit 10b in the pairing display device 10 may be implemented by separate processing circuits, or may be implemented collectively by a single processing circuit.

In the case where the processing circuit is a processor 103 shown in FIG. 4B, the functions of the output processing unit 10a and the detection processing unit 10b in the pairing display device 10 are implemented by software, firmware, or a combination of software and firmware. The software or the firmware is described as programs and the programs are stored in a memory 104.

The processor 103 implements the functions of the output processing unit 10a and the detection processing unit 10b in the pairing display device 10 by reading and executing the programs stored in the memory 104. For example, the pairing display device 10 includes the memory 104 for storing the programs by which the processes of steps ST1 and ST2 in the flowchart shown in FIG. 2 are performed as a result when the programs are executed by the processor 103. These programs cause a computer to perform procedures or methods performed in the output processing unit 10a and the detection processing unit 10b. The memory 104 may be a computer readable storage medium in which the programs for causing the computer to function as the output processing unit 10a and the detection processing unit 10b are stored.

The memory 104 is, for example, a non-volatile or volatile semiconductor memory, such as a random access memory (RAM), a read only memory (ROM), a flash memory, an erasable programmable read only memory (EPROM), and an electrically-EPROM (EEPROM), a magnetic disc, a flexible disc, an optical disc, a compact disc, a mini disc, a DVD, or the like.

Apart of the functions of the output processing unit 10a and the detection processing unit 10b in the pairing display device 10 may be implemented by hardware for exclusive use, and a part of the functions may be implemented by software or firmware. For example, the function of the output processing unit 10a is implemented by the processing circuit 102 which is hardware for exclusive use, and the function of the detection processing unit 10b is implemented by the processor 103's reading and executing a program stored in the memory 104. As mentioned above, the processing circuit can implement the above-mentioned functions by using hardware, software, firmware, or a combination of hardware, software, and firmware.

Next, a variation on the display provided by the pairing display device 10 will be explained.

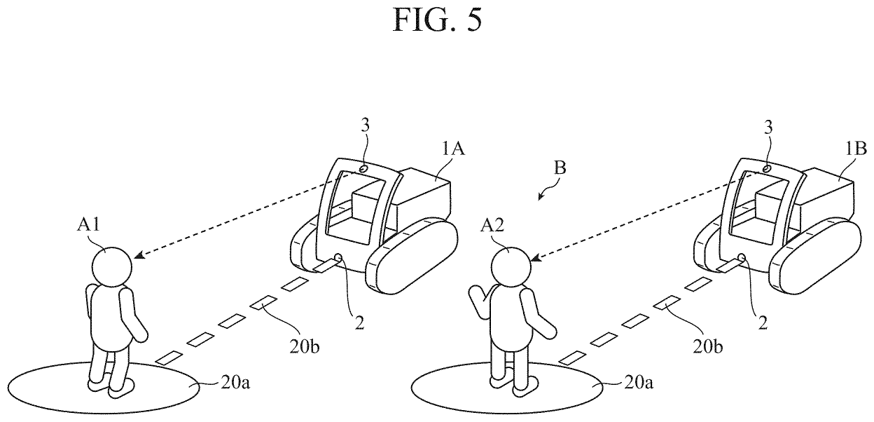

FIG. 5 is a diagram showing a display example of the state of the pairing of a movable object 1A and a user A1, and the state of the pairing of a movable object 1B and a user A2. In FIG. 5, the user A1 is paired with the movable object 1A, and the user A2 is paired with the movable object 1B. The pairing display device 10 is mounted in each of the movable objects 1A and 1B.

The output processing unit 10a of the pairing display device 10 mounted in the movable object 1A displays a state in which the movable object 1A and the user A1 are paired with each other, on a floor B in the vicinity of the movable object 1A by using the display unit 2. Similarly, the output processing unit 10a of the pairing display device 10 mounted in the movable object 1B displays a state in which the movable object 1B and the user A2 are paired with each other, on the floor B in the vicinity of the movable object 1B by using the display unit 2.

For example, after the movable object 1A and the user A1 are paired with each other, the detection processing unit 10b detects the user A1's movement by using the detection unit 3. The output processing unit 10a displays an image 20a under the user A1 and a dotted line image 20b extending from the display unit 2 of the movable object 1A toward the image 20a on the floor B in response to the user A1's movement detected by the detection processing unit 10b, by controlling the display unit 2. Similarly, the output processing unit 10a displays an image 20a under the user A2 and a dotted line image 20b extending from the display unit 2 of the movable object 1B toward the image 20a on the floor B in response to the user A2's movement detected by the detection processing unit 10b.

The user A1 can grasp that the user A2 and the movable object 1B are paired with each other by visually recognizing the image 20a under the user A2 and the dotted line image 20b. On the other hand, the user A2 can grasp that the user A1 and the movable object 1A are paired with each other by visually recognizing the image 20a under the user A1 and the dotted line image 20b. Further, a different user other than the users A1 and A2 can grasp that the movable objects 1A and 1B are excluded from objects to be paired with the different user by visually recognizing the images 20a and 20b.

Further, when the movable object 1A is one that moves while following the user A1, any other user other than the user A1 is alerted to the possibility that, if he/she blocks the path between the user A1 and the movable object 1A, he/she may collide with the movable object 1A, by visually recognizing the images 20a and 20b showing that the movable object 1A and the user A1 are paired with each other. As a result, because any other user other than the user A1 moves in such a way as not to block the path between the user A1 and the movable object 1A, the safety of use of the movable object 1A is improved. The same goes for any other user, including the user A1, other than the user A2.

As mentioned above, the pairing display device 10 according to Embodiment 1 detects the user A who is paired with the movable object 1 by using the detection unit 3, and, when the user A is detected, displays the image 20 showing that the user A is paired with the movable object 1 on the floor B in the vicinity of the movable object 1, by using the display unit 2. The user A can recognize that the user is paired with the movable object 1 which displays the image 20 by visually recognizing the image 20 displayed on the floor B.

Further, the output processing unit 10a of the pairing display device 10 according to Embodiment 1 displays the images 20a and 20b showing a state in which the movable object 1A and the user A1 are paired with each other on the floor B in the vicinity of the movable object 1A. Any other person other than the user A1 can grasp that the user A1 and the movable object 1A are paired with each other by visually recognizing the image 20a under the user A1 and the dotted line image 20b.

### Embodiment 2

A pairing display device according to Embodiment 2 displays an image showing that a user and a movable object are paired with each other on a floor, like that of Embodiment 1, and, after that, displays an image which the user can operate on the floor. Because a user who has realized that he/she is paired with a movable object from the display of an image in Embodiment 1 can recognize that he/she has established pairing with the movable object through his/her own operation on the image in Embodiment 2 (this operation is pseudo because the pairing has been established before the operation), the user can use the movable object 1 with confidence.

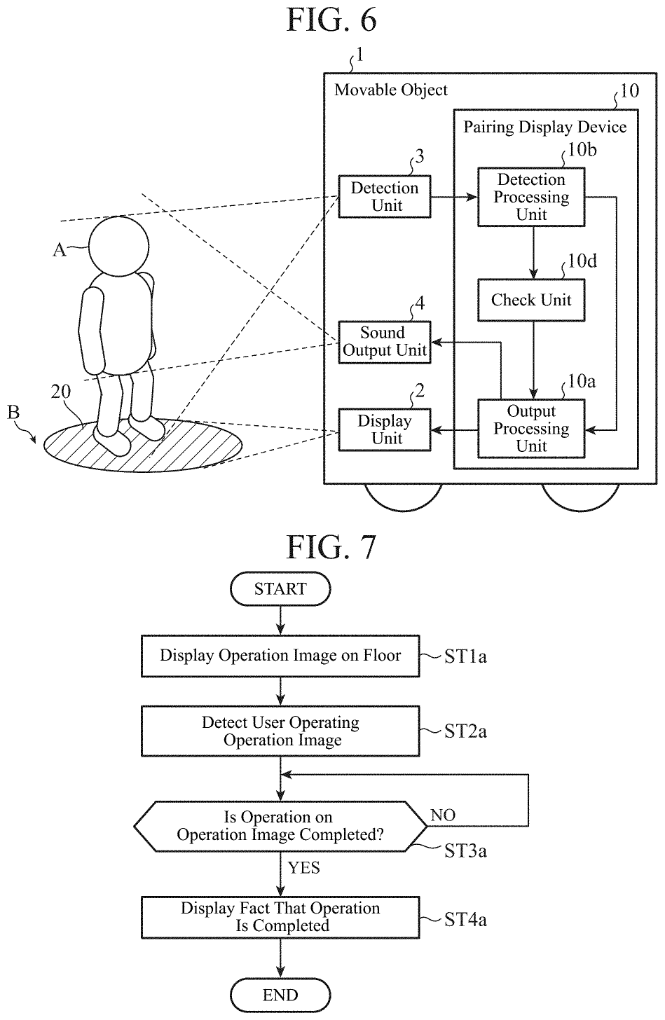

FIG. 6 is a block diagram showing the configuration of the pairing display device 10 according to Embodiment 2. The movable object 1 can perform autonomous movement, like that of Embodiment 1, and, for example, an electric wheelchair, an electric cart, or a mobile robot is provided as the movable object. The movable object 1 shown in FIG. 6 includes a display unit 2, a detection unit 3, a sound output unit 4, and the pairing display device 10. Further, a user A is a person who is paired with the movable object 1, and identification information about the user A is registered in the pairing display device 10.

The pairing display device 10 according to Embodiment 2 performs display about the pairing of the movable object 1 and the user A, and includes an output processing unit 10a, a detection processing unit 10b, and a check unit 10d. The output processing unit 10a displays an image 20 and a progress situation of an operation on this image 20 on a floor B in the vicinity of the movable object 1 by using the display unit 2.

The image 20 in Embodiment 2 is an operation image for urging the user A to perform an operation about the pairing, and the image 20 is formed of a graphic, a character, or a combination of a graphic and a character. The image 20 may be an animation image whose display mode varies with time. In the case where the display unit 2 is a projector, the output processing unit 10a projects the image 20 and display information showing the progress situation of the operation in three dimensions onto the floor B in the vicinity of the movable object 1 by using the projector. As described in Embodiment 1, “display in three dimensions” or “projection in three dimensions” refers to display or projection of information in a form in which the information can be viewed in a stereoscopic manner by human vision. However, the display unit 2 does not necessarily have to display the information in three dimensions, and may perform two-dimensional display of the information.

The output processing unit 10a can display the image 20 in a region which is on the floor B in the vicinity of the movable object 1 and which is the effective detection range of the detection unit 3. The effective detection range is a range where stable detection of an object can be performed by the detection unit 3, and, in the case where the detection unit 3 is, for example, a camera device, the effective detection range is defined by the viewing angle or the like of the camera device. The effective detection range is also referred to as the stable detection range. Because the image 20 is displayed in the region which is the effective detection range of the detection unit 3, the user A can be guided to the region where the user can be detected stably by the detection unit 3.

The output processing unit 10a may change the display mode of the image 20 in response to the progress situation of the operation using the image 20. For example, in a case where the user A operates the image 20 displayed on the floor B using the user's foot, the output processing unit 10a changes the display mode of the image 20 which is operated by the user A's foot detected by the detection processing unit 10b. The user A can recognize that the user A himself/herself has actively established the pairing with the movable object 1, by visually recognizing the display mode of the image 20 which changes in response to the progress situation of the operation. Further, because the user A does not have to directly touch or approach the movable object 1, there is provided an advantage of reducing the possibility that the user carelessly collides with the body of the movable object 1, thereby improving the safety.

The output processing unit 10a displays, on the floor B in the vicinity of the movable object 1, the completion of the operation on the image 20. For example, the output processing unit 10a changes the display mode of the image 20 at the time that the check unit 10d identifies the person who is operating the image 20 as the user A. The user A can easily grasp the completion of the operation on the image 20 by visually recognizing the change of the display mode of the image 20.

The output processing unit 10a may output a sound corresponding to the information displayed on the floor B in the vicinity of the movable object 1 by using the sound output unit 4. Because the output mode of the sound effect is defined by the frequency, the rhythm, and the tempo of the sound effect, the output processing unit 10a may change these. For example, the output processing unit 10a causes the sound output unit 4 to output the sound effect at the time that the operation on the image 20 is started, and causes the sound output unit 4 to change the output mode of this sound effect in response to the progress situation of the operation. When the person who is operating the image 20 is identified as the user A, the output processing unit 10a changes the output mode of the sound effect which has been outputted until the user A is identified to a different mode. As a result, the user A can realize the operation on the image 20 visually and acoustically.

The detection processing unit 10b detects the user A who is operating the image 20, by using the detection unit 3. The identification information about the user A is set in the detection processing unit 10b. The identification information includes pieces of personal information for identifying the user A, such as gender, age, and face information, and may include appearance information about the user A. The appearance information about the user A may indicate the user A's clothes or hairstyle, whether or not the user A is using a cane, or a combination of these characteristics when the user operates the image 20. For example, the detection processing unit 10b performs an image analysis on an image of an area in the vicinity of the movable object 1, the image being captured by the camera device which is the detection unit 3, to detect the user A from the image on the basis of the appearance information about the user A and a result of the image analysis. As the image analysis, an image analysis method such as pattern matching can be used.

The check unit 10d checks the progress situation of an operation on the image 20. For example, the check unit 10d determines the progress situation of an operation on the image 20 on the basis of a result of the image analysis on an image of the user A's foot detected by the detection processing unit 10b. The progress situation of the operation on the image 20, which is checked by the check unit 10d, is sequentially outputted to the output processing unit 10a.

Next, a pairing display method according to Embodiment 2 will be explained in detail.

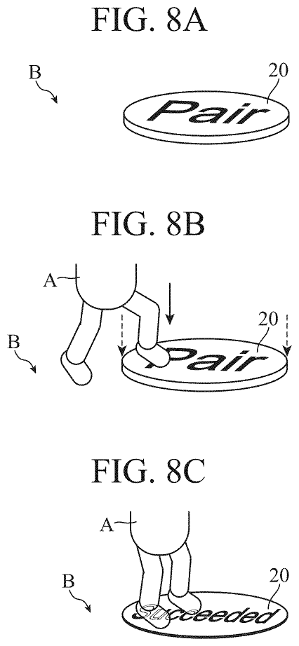

FIG. 7 is a flowchart showing the pairing display method according to Embodiment 2. Before the processing shown in FIG. 7 is performed, the image 20 in Embodiment 1 (image showing that the movable object 1 and the user A are paired with each other) is displayed on the floor B, so that the user A recognizes that the user is paired with the movable object 1. Further, FIG. 8A is a diagram showing an example of the image 20 for urging the user A to perform an operation, and shows the image 20 displayed in three dimensions on the floor B and having a push button shape. The image 20 shown in FIG. 8A is projected by the display unit 2 onto the floor B in three dimensions. FIG. 8B is a diagram showing the progress situation of an operation on the image 20 of FIG. 8A. FIG. 8C is a diagram showing the completion of the operation on the image 20 of FIG. 8A.

The output processing unit 10a displays the image 20 for operation on the floor B in the vicinity of the movable object 1 by using the display unit 2 (step ST1a) . For example, as shown in FIG. 8A, a push button on which characters “pair” showing that this is an image for an operation about pairing are written is displayed, as the image 20 for operation, on the floor B. Because the push button is displayed on the floor B, the user A can push down the push button using the user's foot even in a state where the user cannot use both hands for operation.

The detection processing unit 10b detects the user A who is operating the image 20 for operation (step ST2a). For example, the detection processing unit 10b detects a foot of the user A who is operating (pushing down) the push button, and outputs information about this detection to the check unit 10d. The check unit 10d checks the progress situation of the operation on the image 20, and outputs the progress situation to the output processing unit 10a. The output processing unit 10a changes the display mode of the image 20 described in step ST1a in response to the progress situation of the operation on the image 20. For example, as shown in FIG. 8B, the output processing unit 10a changes the image into an image in which the push button is gradually pushed down, by using the display unit 2. At this time, the output processing unit 10a may change the output mode of the sound effect in response to the pushing down of the push button, by using the sound output unit 4.

The check unit 10d checks whether or not the operation on the image 20 is completed (step ST3a) . For example, the check unit 10d determines the completion of the operation on the basis of whether the position of the user's A foot detected by the detection processing unit 10b has touched the floor B. When the operation on the image 20 is not completed (when NO in step ST3a), the process of step ST3a is repeated.

In contrast, when the operation on the image 20 is completed (when YES in step ST3a), the output processing unit 10a displays the fact that the user A's operation is completed (step ST4a). For example, as shown in FIG. 8C, the image of the push button is changed to an image in a state where the push button is completely pushed down. In addition, the characters “Pair” written on the push button may be changed to characters “Succeeded” showing that the pairing of the movable object 1 and the user A has succeeded. At this time, the output processing unit 10a may change the output mode of the sound effect outputted from the sound output unit 4 to a mode different from the one which is set until the operation has been completed. The display mode of the image 20 displayed on the floor B and the sound effect outputted from the sound output unit 4 make it possible for the user A to recognize that the pairing with the movable object 1 has been established through the user's own operation.

When it is determined that the person detected by the detection processing unit 10b is a third person other than the user A, the output processing unit 10a may temporarily change the characters written on the push button which is the image 20 to display of information showing that the person is not the user to be paired, such as “You are not the user of this movable object.” The characters and the text which are displayed by the output processing unit 10a may be displayed either in the language usually used in the area where the display device is used or in another language. Further, the display may be performed while the language is changed according to identification status of the user detected by the detection processing unit 10b.

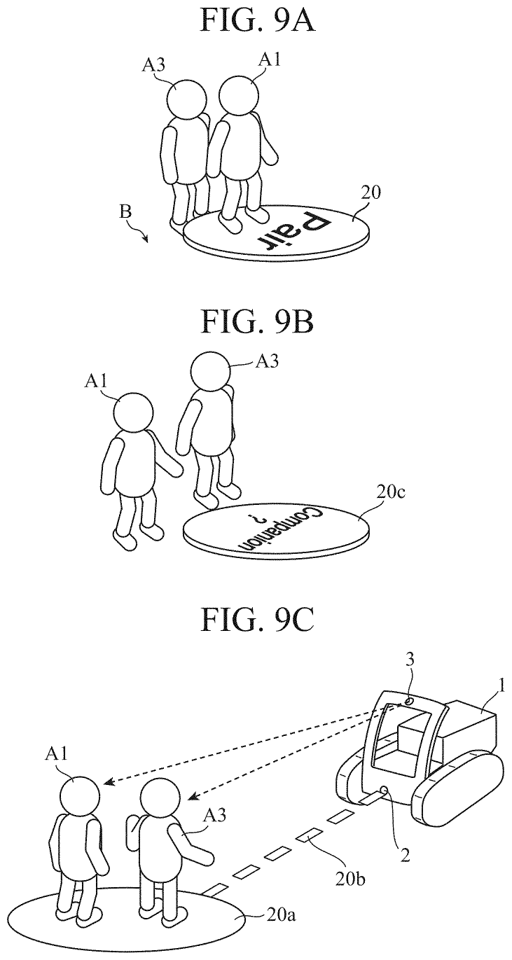

A target person to be paired with the movable object may include not only a user but a companion of the user. The detection processing unit 10b detects a person present in the vicinity of the user A1 who is operating the image 20, by using the detection unit 3, as shown in FIG. 9A. When the operation by the user A1 is completed, the output processing unit 10a displays a confirmation image for an operation to confirm whether or not the person detected by the detection processing unit 10b is a companion A3 of the user A1. For example, a push button 20c as shown in FIG. 9B is displayed on the floor B by the output processing unit 10a. On the push button 20c, characters “Companion?” showing that this is the image for the operation to confirm whether or not the person is a companion are written. The companion A3 pushes down the push button 20c using the companion's foot.

The detection processing unit 10b detects the companion A3 who is operating the pushbutton 20c, and outputs information about the detection to the check unit 10d. The check unit 10d checks the progress situation of the companion A3's operation on the image of the push button 20c on the basis of a result of performing an image analysis on the image of the companion A3's foot detected by the detection processing unit 10b. The output processing unit 10a changes the image 20 to an image in which the push button is gradually pushed down, in response to the progress situation of the operation checked by the check unit 10d. The output processing unit 10a may change the output mode of the sound effect in response to the pushing down of the push button 20c, by using the sound output unit 4.

When the check unit 10d determines that the companion A3's operation on the push button 20c is completed, the output processing unit 10a displays an image showing that the movable object 1, and a group of the user A1 and the companion A3 are paired with each other on the floor B. When the group of the user A1 and the companion A3 is paired with the movable object 1, not only the user A1's action but also the companion A3's action is reflected in the movement of the movable object 1. For example, in the case where the movable object 1 is one that moves while carrying the user A1, and the companion A3 moves while following this movable object 1, even when the companion A3 takes an action different from that by the user A1, the movable object 1 takes an action which conforms to the companion A3. For example, when the companion A3 stops suddenly during the movement of the movable object 1, the movable object 1 stops in response to the companion A3's stopping. As a result, both the user A1 and the companion A3 can act together without getting separated from each other.

Further, after the movable object 1, and the group of the user A1 and the companion A3 are paired with each other, the output processing unit 10a may display an image showing a state where the movable object 1, and the group of the user A1 and the companion A3 are paired with each other, on the floor B in the vicinity of the movable object 1. For example, as shown in FIG. 9C, the output processing unit 10a displays an image 20a under both the user A1 and the companion A3, and an image 20b extending from the display unit 2 to the image 20a and having a dotted line shape on the floor B in response to the movements of both the user A1 and the companion A3. A different user other than both the user A1 and the companion A3 can grasp that the group of the user A1 and the companion A3 is paired with the movable object 1, and the movable object 1 is excluded from objects to be paired with the different user, by visually recognizing the images 20a and 20b.

The functions of the output processing unit 10a, the detection processing unit 10b, and the check unit 10d in the pairing display device 10 are implemented by a processing circuit. More specifically, the pairing display device 10 includes a processing circuit for performing steps ST1a to ST4a shown in FIG. 7. The processing circuit may be either hardware for exclusive use or a CPU that executes a program stored in a memory.

As mentioned above, the pairing display device 10 according to Embodiment 2 displays the image 20 for the user A to perform an operation about pairing on the floor B in the vicinity of the movable object 1, and detects the user A who is operating the image 20. Because the user A can recognize that he/she has established pairing with the movable object 1 through his/her own operation, the user A can use the movable object 1 with confidence.

### Embodiment 3

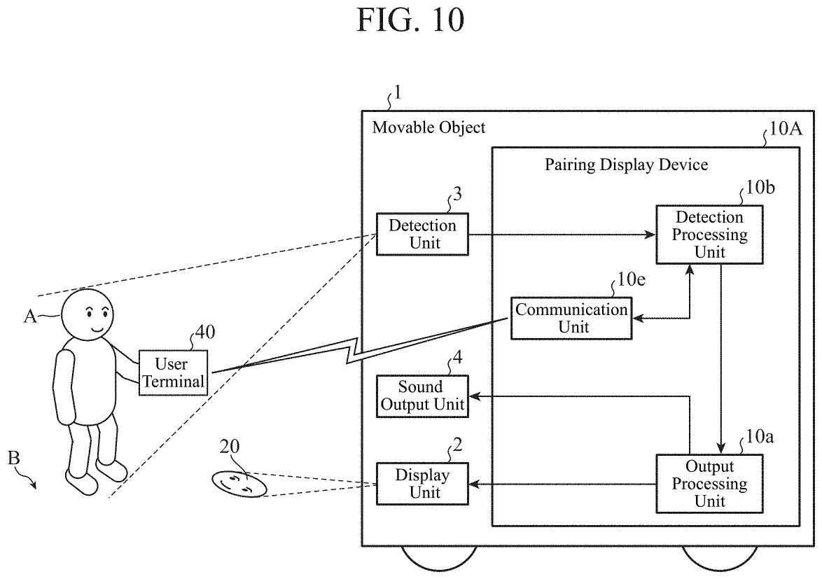

FIG. 10 is a block diagram showing the configuration of a pairing display device 10A according to Embodiment 3. A movable object 1 can perform autonomous movement, and, for example, an electric wheelchair, an electric cart, or a mobile robot is provided as the movable object. The movable object 1 shown in FIG. 10 includes a display unit 2, a detection unit 3, a sound output unit 4, and the pairing display device 10A. A user A is one who has registered for a service that allows the user to use the movable object 1, and identification information about the user A is set in the pairing display device 10A. The user A is carrying a user terminal 40. The user terminal 40 is a terminal device that communicates with the pairing display device 10A, and is, for example, a smartphone, a mobile telephone terminal, or a tablet information terminal.

The user A can transmit appearance information about the user A to the pairing display device 10A by using the user terminal 40. The appearance information about the user A indicates the user A's clothes or hairstyle, whether or not the user A is using a cane, or a combination of these characteristics at the place where the movable object 1 is located.

The pairing display device 10A performs display about the pairing of the movable object 1 and the user A, and, for example, is mounted in the movable object 1. As shown in FIG. 10, the pairing display device 10A includes an output processing unit 10a, a detection processing unit 10b, and a communication unit 10e. As shown in FIG. 3, these components may be included in a server 30.

The user A transmits usage reservation data to the pairing display device 10A mounted in the movable object 1 by using the user terminal 40 before going to the place where the movable object 1 is located. The communication unit 10e which the pairing display device 10A includes communicates with the user terminal 40, to receive the usage reservation data, and outputs the received usage reservation data to the detection processing unit 10b. When receiving the usage reservation data, the detection processing unit 10b recognizes that the pairing of the movable object 1 and the user A has been established.

The detection processing unit 10b transmits information indicating that the pairing with the movable object 1 by the user A has been established to the user terminal 40 via the communication unit 10e. When the pairing with the movable object 1 has been established, the user A transmits the appearance information about the user A to the pairing display device 10A by using the user terminal 40. The communication unit 10e outputs the appearance information about the user A received from the user terminal 40 to the detection processing unit 10b.

The detection processing unit 10b detects a person present in the vicinity of the movable object 1, and determines whether the appearance of the detected person matches the appearance information about the user A. When the person present in the vicinity of the movable object 1 matches the appearance information about the user A, the detection processing unit 10b determines that the person is the user A. When the user A is detected by the detection processing unit 10b, the output processing unit 10a displays an image 20 on a floor B in the vicinity of the movable object 1 by using the display unit 2.

The functions of the output processing unit 10a, the detection processing unit 10b, and the communication unit 10e in the pairing display device 10A are implemented by a processing circuit. More specifically, the pairing display device 10A includes a processing circuit for performing the processing mentioned above. The processing circuit may be either hardware for exclusive use or a CPU that executes a program stored in a memory.

As mentioned above, in the pairing display device 10A according to Embodiment 3, the communication unit 10e receives the appearance information about the user A which is transmitted using the user terminal 40. The detection processing unit 10b detects the user A by using the appearance information received by the communication unit 10e. When the user A is detected by the detection processing unit 10b, the output processing unit 10a displays the image 20 showing that the user A is paired with the movable object 1 on the floor B in the vicinity of the movable object 1. The user A can recognize that the user is paired with the movable object 1 which displays the image 20 on the floor B, by visually recognizing the image 20 displayed on the floor B.

It is to be understood that the present disclosure is not limited to the above-mentioned embodiments, and any combination of two or more of the above-mentioned embodiments can be made, various changes can be made in any component according to any one of the above-mentioned embodiments, or any component according to any one of the above-mentioned embodiments can be omitted within the scope of the present disclosure.

### INDUSTRIAL APPLICABILITY

The pairing display device according to the present disclosure can be used for, for example, the pairing of a movable object, such as an electric wheelchair, an electric cart, and a mobile robot, and a user.

### REFERENCE SIGNS LIST

1, 1A, 1B movable object, 2 display unit, 3 detection unit, 4 sound output unit, 5 communication unit, 10, 10A pairing display device, 10a output processing unit, 10b detection processing unit, 10c, 10e communication unit, 10d check unit, 20, 20a, 20b image, 20c push button, 30 server, 40 user terminal, 100 input interface, 101 output interface, 102 processing circuit, 103 processor, and 104 memory.

1. A pairing display device comprising:
processing circuitry
to detect a user who is paired with a movable object having a projector and a detector, by using the detector; and
to display, when the user is detected, information showing that the user is paired with the movable object on a floor in a vicinity of the movable object, by using the projector, wherein
the processing circuitry displays an image showing a state in which the movable object and the user are paired with each other on the floor in the vicinity of the movable object.

2. The pairing display device according to claim 1, wherein
the processing circuitry displays an operation image for an operation about the pairing of the movable object and the user on the floor in the vicinity of the movable object, by using the projector, and
the processing circuitry detects the user who is operating the operation image by using the detector.

3. The pairing display device according to claim 2, wherein the processing circuitry displays the operation image in a region which is on the floor in the vicinity of the movable object and which is an effective detection range of the detector.

4. The pairing display device according to claim 1, wherein
the projector projects an image onto the floor in the vicinity of the movable object, and
the processing circuitry displays an image including a line, a graphic, a character, or a combination of a line, a graphic, and a character, as the image showing the state in which the movable object and the user are paired with each other, by using the projector.

5. The pairing display device according to claim 2, wherein the processing circuitry checks a progress situation of the operation on the operation image.

6. The pairing display device according to claim 1, wherein
the processing circuitry detects a companion of the user by using the detector, and
when the companion is detected, the processing circuitry displays information showing that a group of the user and the companion, and the movable object are paired with each other on the floor in the vicinity of the movable object.

7. The pairing display device according to claim 1, wherein
the processing circuitry communicates with a user terminal,
the processing circuitry receives usage reservation data which the user transmits using the user terminal, and
when the user who has transmitted the usage reservation data using the user terminal is detected, the processing circuitry displays information showing that the user is paired with the movable object on the floor in the vicinity of the movable object, by using the projector.

8. The pairing display device according to claim 1, wherein
the movable object includes a speaker, and
the processing circuitry outputs a sound corresponding to the information displayed on the floor in the vicinity of the movable object, by using the speaker.

9. A pairing display system comprising:
a movable object having a projector and a detector; and
processing circuitry
to detect a user who is paired with the movable object, by using the detector; and
to display, when the user is detected, information showing that the user is paired with the movable object on a floor in a vicinity of the movable object, by using the projector, wherein
the processing circuitry displays an image showing a state in which the movable object and the user are paired with each other on the floor in the vicinity of the movable object.

10. A pairing display method comprising:
detecting a user who is paired with a movable object having a projector and a detector, by using the detector;
when the user is detected, displaying information showing that the user is paired with the movable object on a floor in a vicinity of the movable object, by using the projector; and
displaying an image showing a state in which the movable object and the user are paired with each other on the floor in the vicinity of the movable object.
